(19) United States
(12) Patent Application Publication
(10) Pub. No.: US 2011/0202645 A1
(43) Pub. Date: Aug. 18, 2011

(54) Methods and Apparatus to Test Network Elements

(75) Inventors: Ahmed Mohamed Abdelal, North Andover, MA (US); Wassim Matragi, North Andover, MA (US); Jeff Wall, Dallas, TX (US)

(73) Assignee: Sonus Networks, Inc., Westford, MA (US)

(21) Appl. No.: 12/705,236

(22) Filed: Feb. 12, 2010

(51) Int. Cl. G06F 15/173; G06F 17/30

(52) U.S. Cl. 709/223

(57) ABSTRACT

Described are computer-based methods and apparatuses, including computer program products, for testing network elements in a communication network. A record file is received, comprising one or more record file elements, each record file element including data indicative of a request received by a network element in a network during normal operation. A virtual client is created for each of one or more identified sources. One or more regenerated requests are generated, each of the one or more regenerated requests being generated based on data in a corresponding record file element from the one or more record file elements. For each of the one or more regenerated requests, the virtual client associated with the regenerated request transmits the regenerated request to a subject network element to test the subject network element, wherein the one or more regenerated requests simulate requests received by the network element during normal operation.

### FIELD OF THE INVENTION

The present invention relates generally to computer-based methods and apparatuses, including computer program products, for testing network elements, and in particular testing elements of a telecommunications network.

### BACKGROUND

Test networks are often used to evaluate network elements prior to their deployment in an active network. Advantageously, the performance of the network elements can be verified before the network element is actually used. Such testing can prevent undesirable side effects caused by an underperforming network element, which can cause network crashes, network traffic bottlenecks, loss of bandwidth, wasted bandwidth, loss of data, failed connections or requests, and other undesirable side effects.

For example, telecommunications networks are used to transmit communication signals (e.g., voice calls, data messaging, etc.). A telecommunications network is a network of telecommunications links and nodes arranged so that messages may be passed from one part of the network to another over multiple links and through various nodes (e.g., wireless networks, wireline networks, and the like). IP Multimedia Subsystem (IMS, an architectural framework for delivering Internet Protocol (IP) multimedia services) networks aid the access of multimedia and voice applications from wireless and wireline terminals (e.g., IMS networks create a form of fixed-mobile convergence (FMC)). In the context of IMS networks, for example, the network element under test can be a call processing element (e.g., a softswitch, a Proxy Call Session Control Function (P-CSCF), an Interrogating Call Session Control Function (I-CSCF), a Serving Call Session Control Function (S-CSCF), a Media Gateway (MG), a Media Gateway Controller (MGC), an Application Server (AS), or a Database (e.g. Home Subscriber Service (HSS)). It is desirable to test such network elements to verify the telecommunications network will not be negatively impacted by adding a new network element and/or changing an existing network element.

For example, a softswitch is a central device in a telecommunications network which connects calls from one phone line to another. A softswitch is typically used to control connections at the junction point between circuit and packet networks. For example, to handle a mobile origination or mobile termination call to the Public Switched Telephone Network (PSTN), telecommunication networks can include a gateway switch to handle communication with the PSTN and/or other mobile networks (e.g., the gateway switch can handle media to and from the public switched telephone network). A gateway controller (a softswitch) in communication with the gateway switch routes calls to the PSTN or any other circuit-based network, providing service selection and routing for VoIP and multimedia services across the application architecture. The gateway controller can handle, for example, routing and provisioning. However, due to the versatility and complexity of the services offered by these network elements, such as the softswitch, accurately benchmarking their performance footprint and capacity by traditional methods is unfeasible.

### SUMMARY OF THE INVENTION

Quite often, simulated data or messages are used to test network elements (e.g., a softswitch) to see how well the network element performs under various loads. Such simulated data can be created to mimic the messages the network element would be subjected to in an active network (e.g., a deployed telecommunications network). However, it is difficult to create simulated data that properly emulates that of an active network. This can result in inconclusive, incorrect, incomplete, and/or misleading tests of the network elements, resulting in increased risk and uncertainty of using the network elements in an active network. Further, it is desirable to be able to test network elements that are deployed in active networks with accurate data and/or messages to verify continued proper performance of the network elements (e.g., to verify performance if other network elements are changed in a way that could affect the performance of the network element under test).

The invention, in one aspect, features a computerized method for testing network elements in a communication network. The method includes receiving, by a load generator server, a record file comprising one or more record file elements, each record file element including data indicative of a request received by a network element in a network during normal operation. The method includes storing, by the load generator server, the record file in a database in communication with the load generator server. The method includes identifying, by the load generator server, one or more sources associated with the one or more record file elements based on data in each record file element. The method includes creating, by the load generator server, a virtual client for each of the one or more identified sources. The method includes, for each of the one or more record file elements in the record file, generating, by the load generator server, one or more regenerated requests, each of the one or more regenerated requests being generated based on data in a corresponding record file element from the one or more record file elements. the method includes, for each of the one or more regenerated requests, transmitting, by the virtual client associated with the regenerated request, the regenerated request to a subject network element to test the subject network element, wherein the one or more regenerated requests simulate requests received by the network element during normal operation.

In another embodiment, the record file is generated by the network element based on one or more requests received by the network element and one or more responses transmitted by the network element, during normal operation, the record file is generated by a second network element based on the one or more requests and the one or more responses, or any combination thereof. The network element can be a softswitch, the communications network can be a telecommunications network, and each record file element can be a call detail record (CDR). The one or more record file elements can include a stop CDR, and the method can further include, for each of the one or more regenerated requests, determining a call start time for the regenerated request based on a creation time of an associated stop CDR and a call holding time of the associated stop CDR.

In another embodiment, the data in each record file element includes data indicative of a calling number for a request associated with the record file element, data indicative of a receiving number for the request, data indicative of a date of the request, data indicative of a time of the request, data indicative of a duration of the request, data indicative of a call type of the request, data indicative of a routing label for the request, data indicative of a message bill indicator for the request, or any combination thereof. The method can include receiving a response from the subject network element, wherein the subject network element generated the response based on a regenerated request from the one or more regenerated requests transmitted to the subject network element, and validating the response based on data stored in a corresponding record file element used to generate the regenerated request.

In another embodiment, validating includes determining that one or more pieces of data in the response do not match the data stored in the corresponding record file element, and generating a warning message indicative of the one or more pieces of data not matching the data stored in the corresponding record file element. The method can include determining a transmission rate for the one or more regenerated requests based on the record file. Transmitting can include transmitting the one or more regenerated requests at the transmission rate, or adjusting the transmission rate to increase the transmission rate, decrease the transmission rate, or any combination thereof, to generate an adjusted transmission rate, and transmitting the one or more regenerated requests at the adjusted transmission rate.

In another embodiment, generating includes, for one or more of the one or more regenerated requests, modifying one or more fields of the regenerated request to generate a different distribution of the one or more regenerated requests than a distribution of the one or more regenerated requests without any fields being modified. Creating the virtual client for each of the one or more identified sources can include registering the virtual client with the subject network element before transmitting any of the one or more regenerated requests from the virtual client to the subject network element. The method can include transmitting one or more maintenance messages to the subject network element to verify a connection between the subject network element and the load generator server.

In another embodiment, the method includes determining the subject network element failed to respond to a regenerated request from the one or more regenerated requests within a predetermined time period, and retransmitting the regenerated request to the subject network element. The subject network element can include load control, and the method can further include receiving one or more load control messages from the subject network element indicative of data for load control, and adjusting the transmission of the one or more regenerated requests to adjust a transmission rate of the transmission, a distribution of the transmission, or any combination thereof, based on the load control messages. The subject network element and the load generation server can be deployed in a testing network, deployed in an operational network, or any combination thereof.

In another embodiment, the method includes transmitting the one or more regenerated requests to a plurality of subject network elements, including transmitting the one or more regenerated requests to a first subject network element, wherein the one or more regenerated requests include data indicative of instructions for the first subject network element to forward the one or more regenerated requests to a second subject network element, or load balancing the one or more regenerated requests between the first subject network element and the second subject network element, or any combination thereof. Load balancing can include transmitting the one or more regenerated requests based on a first overload state of the first subject network element and a second overload state of the second subject network element.

The invention, in another aspect, features a computer program product, tangibly embodied in an information carrier. The computer program product includes instructions being operable to cause a data processing apparatus to receive a record file comprising one or more record file elements, each record file element including data indicative of a request received by a network element in a network during normal operation. The computer program product further includes instructions being operable to cause a data processing apparatus to store the record file in a database in communication with the load generator server. The computer program product further includes instructions being operable to cause a data processing apparatus to identify one or more sources associated with the one or more record file elements based on data in each record file element and to create a virtual client for each of the one or more identified sources. The computer program product further includes instructions being operable to cause a data processing apparatus to, for each of the one or more record file elements in the record file, generate one or more regenerated requests, each of the one or more regenerated requests being generated based on data in a corresponding record file element from the one or more record file elements. The computer program product further includes instructions being operable to cause a data processing apparatus to, for each of the one or more regenerated requests, transmit the regenerated request to a subject network element to test the subject network element, wherein the one or more regenerated requests simulate requests received by the network element during normal operation.

The invention, in another aspect, features an apparatus. The apparatus is for testing network elements in a communication network. The apparatus includes a database configured to store record files. The apparatus includes a load generator server in communication with the database. The load generator server being configured to receive a record file comprising one or more record file elements, each record file element including data indicative of a request received by a network element in a network during normal operation and to store the record file in the database. The load generator server is configured to identify one or more sources associated with the one or more record file elements based on data in each record file element and to create a virtual client for each of the one or more identified sources. The load generator server is configured to, for each of the one or more record file elements in the record file, generate one or more regenerated requests, each of the one or more regenerated requests being generated based on data in a corresponding record file element from the one or more record file elements. The load generator server is configured to, for each of the one or more regenerated requests, transmit the regenerated request to a subject network element to test the subject network element, wherein the one or more regenerated requests simulate requests received by the network element during normal operation.

The techniques, which include both methods and apparatuses, described herein can provide one or more of the following advantages. The messages (e.g., regenerated requests) are regenerated from a record file (e.g., records or logs written by the network element under test, or generated based on responses from the network element under test) during its normal operation in an active network. The regenerated messages reflect actual traffic and/or messages received by the network component under test. Tests can be applied to the network element using the regenerated messages, which accurately emulate the same level and type of load the network element under test would encounter during normal operation. Engineers can accurately determine the performance of a network element by regenerating and replaying past recorded messages (e.g., call requests, call termination messages, and other data and/or messages transmitted to the network element under test). Additionally, the sources of the original requests can be emulated using virtual clients to provide for an accurate testing scenario to the network element. The virtual clients can be configured to send, in addition to the regenerated messages, maintenance messages and various other requests/messages typically sent by a virtual client. Advantageously, by sending these additional messages, the virtual clients appear to be actual clients (i.e., sources) to the network element being tested.

The systems and methods described herein provide for different modes for replaying the regenerated messages (e.g., transmitting the regenerated requests at the same pace as the original requests, transmitting the requests at a given fixed rate or a given rate distribution). The systems and methods can be deployed to test a single network element (e.g., by sending a request to a database server, which will process the request and sends back the response) and/or to test multiple elements (e.g., send a request to a database server, which forwards the request to another server, and so on before the database server forms the response).

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a schematic illustration of a network for testing network elements, according to an illustrative embodiment of the invention;

FIG. 2 is a schematic illustration of a network for testing network elements, according to an illustrative embodiment of the invention;

FIG. 3 is a schematic illustration of the use of a record file, according to an illustrative embodiment of the invention;

FIG. 4 is a schematic illustration of a method for testing network elements, according to an illustrative embodiment of the invention;

FIG. 5 is a schematic illustration of a method for validating responses received from the network element under test, according to an illustrative embodiment of the invention;

FIG. 6 is a schematic illustration of a method for adjusting the transmission of regenerated requests, according to an illustrative embodiment of the invention; and

FIG. 7 is a schematic illustration of a method for emulating request sources, according to an illustrative embodiment of the invention.

### DETAILED DESCRIPTION

In general overview, a record file includes data indicative of a request (e.g., messages) received by a network element (e.g., a softswitch, such as a gateway controller) in a network (e.g., a telecommunications network, such as an IMS network) during normal operation. One or more sources (e.g., one or more gateway switches) associated with the data in the record file (e.g., call detail records (CDRs)) are identified. A virtual client (e.g., virtual gateway switches) are created for each of the one or more identified sources. Regenerated requests are generated based on data in the record file (e.g., the CDRs), and are transmitted by the virtual clients to a subject network element (e.g., the softswitch used to generate the record file or a different softswitch) to simulate requests received by the network element during normal operation. Although the specification and/or figures describe the techniques mostly in terms of IMS networks and softswitches, these techniques work equally as well on any type of network, such as IP networks, video-on-demand (VOD) networks, and any other type of network.

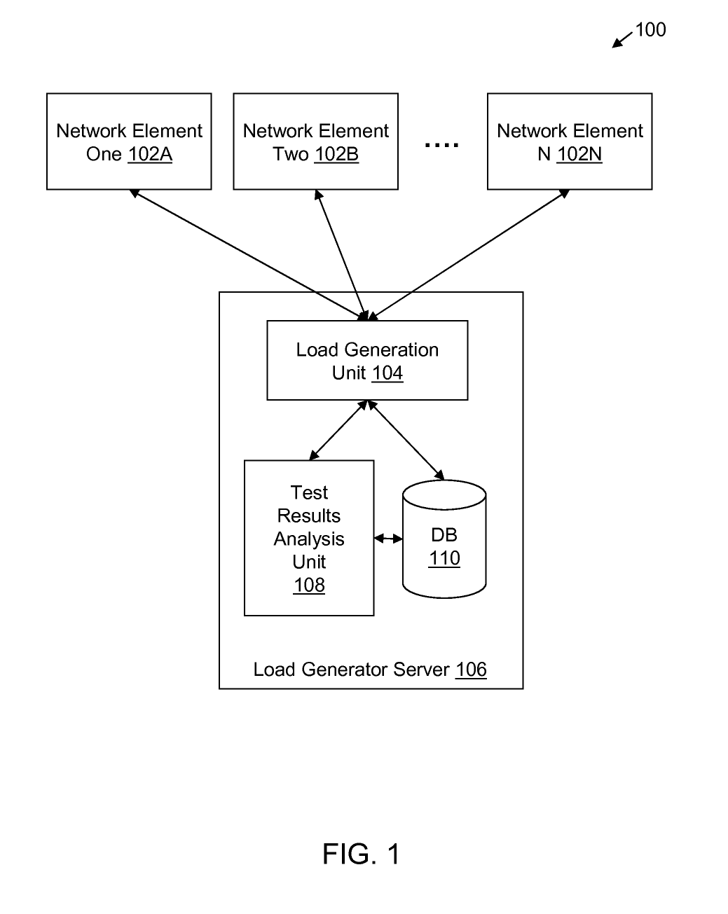

FIG. 1 is a schematic illustration of a network 100 for testing network elements, according to an illustrative embodiment of the invention. The network 100 includes network element one 102A, network element two 102B through network element 102N (collectively referred to as network elements 102). The network elements 102 are in communication with the load generation unit 104 of the load generation server 106. The load generator server 106 includes a test results analysis unit 108 in communication with the load generation unit 104. The load generator server 106 includes a database (DB) 110 in communication with the load generation unit 104 and the test results analysis unit 108.

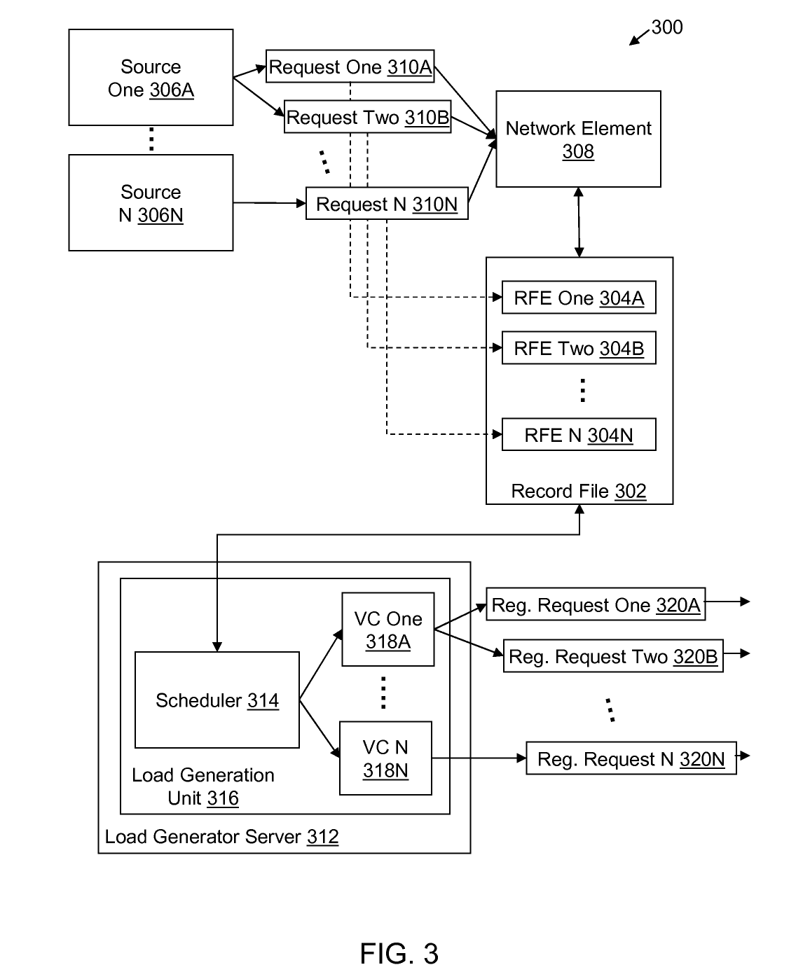

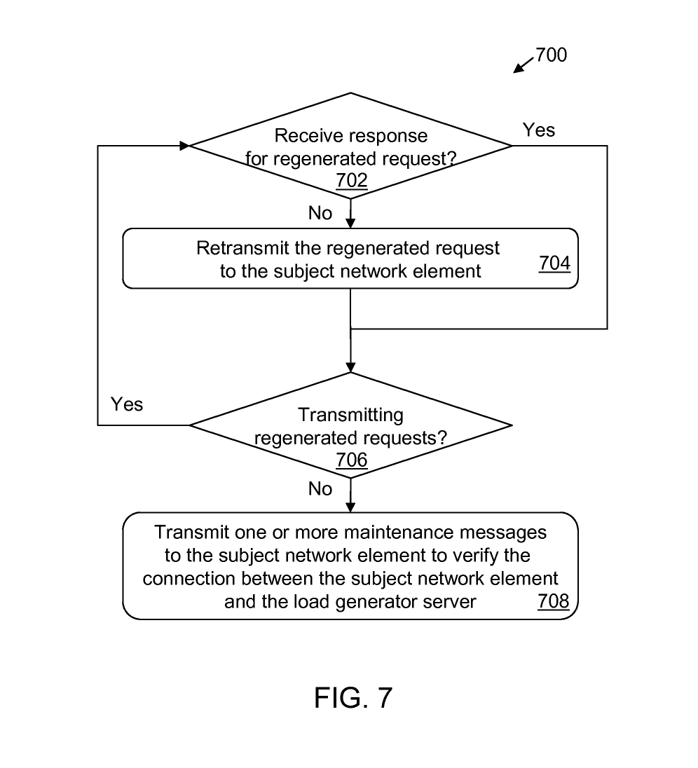

The load generator server 106 is configured to create (e.g., based on messages and/or responses from the network elements 102) or receive (e.g., from the network elements 102) record files, which are explained with reference to FIG. 3. The load generator server 106 stores record files and other necessary information in the database 110. The load generation unit 104 is configured, for example, to read the record files, filter record file elements within the record files (e.g., to remove unnecessary record file elements, sort the record file elements for playback, etc.), and to generate the load on the network elements 102A using a built-in scheduler (not shown, e.g., the scheduler 314 of FIG. 3). The test results analysis unit 108 is configured to enable batch testing and analysis of the results of one or more tests executed in sequence by the load generator server 106 (e.g., to analyze results of regenerated requests sent by the load generation unit 104 to the network elements 102). The test results analysis unit 108 can be configured by a user (e.g., via a comma-separated values (csv) file or other configuration methods) to define settings for the batch tests (e.g., the initial transmission rate for the regenerated requests, the final transmission rate for the regenerated requests, transmission rate increments, the number of requests or calls to use for each test, and other settings). During each test, the test results analysis unit 108 collects performance metrics from the network element under test (performance metrics are described with reference to step 702 of FIG. 7 below).

While the network 100 shows a plurality of network elements 102, the network 100 can include any number of network elements. The network elements 102 can be any running element within the network. For example, a softswitch, P-CSCF, I-CSCF, S-CSCF, MG, MGC, AS, or a DB, such as an HSS. The network elements 102 can be deployed in an operational network (e.g., an operational IMS network servicing active clients), a test network (e.g, a network not connected to active clients and being configured to perform and run tests on network elements within the test network), or any other type of network. For example, the load generator server 106 can run as a standalone tool for lab testing, or can be integrated into a proactive network monitoring system that continuously run tests against live network elements in an operation network (e.g., as a part of network health check). In the network monitoring system example, the load generator server 106 can, for example, continuously or on-demand test a desired network element (e.g., one or more of the network elements 102), and can send collected performance metrics to the test results analysis unit 108, which performs the analysis and visualization of the tests run on the desired network element(s). In some embodiments, the test results analysis unit 108 can correlate the load generation unit 104 metrics to metrics collected from other network elements to, for example, anticipate future problems of the network elements and/or the network as a whole or to help identify the root cause of existing problems in the network.

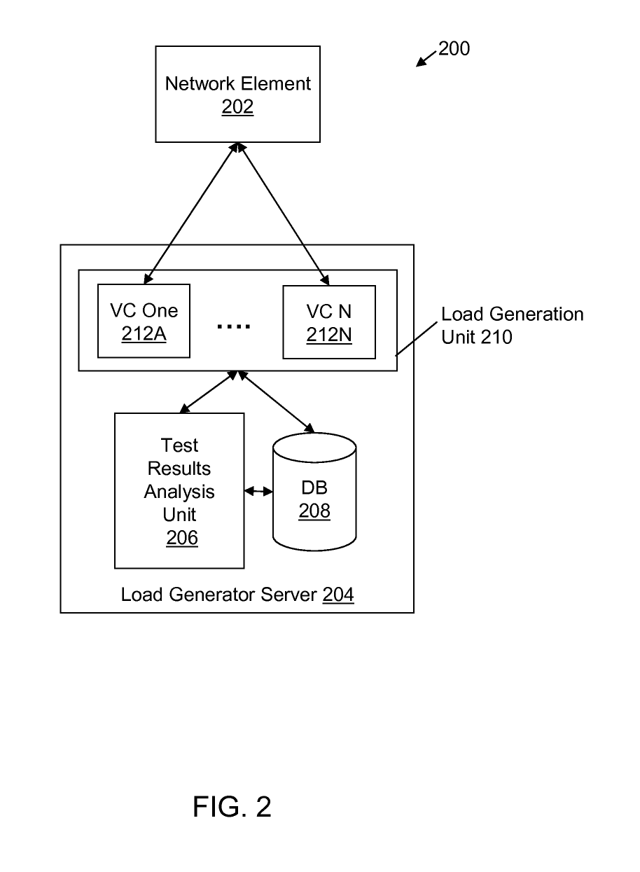

FIG. 2 is a schematic illustration of a network 200 for testing network elements, according to an illustrative embodiment of the invention. Configuration 200 includes a network element 202 (e.g., a network element from the network elements 102). Similar to FIG. 1, the network 200 includes a load generator server 204 (e.g., the load generator server 106 of FIG. 1) that is in communication with the network element 202. The load generator server 204 includes a test results analysis unit 206 (e.g., the test results analysis unit 108 of FIG. 1). The load generator server 204 includes a database (DB) 208 in communication with the test results analysis unit 206 (e.g., DB 110 of FIG. 1). The load generator server 204 further includes a load generation unit 210 that is in communication with the test results analysis unit 206 and the database 208 (e.g., load generation unit 104 of FIG. 1).

The load generation unit 210 includes virtual client (VC) one 212A through virtual client 212N (collectively referred to as virtual clients 212). The load generator server 204 creates the virtual clients 212 when transmitting regenerated requests to the network element 202 to test the network element 202. As will be described with reference to FIG. 3, the load generation unit 210 creates virtual clients 212 to emulate the sources of the requests that are used to build the record file. The virtual clients 212 can be configured to send not only the regenerated requests, but also other messages and information to the network element being tested to emulate all the messages the network element would receive when deployed in an operational network (e.g., registration messages, maintenance messages, and/or other messages sent by the sources during operation in an active network).

FIG. 3 is a schematic illustration 300 of the use of a record file 302, according to an illustrative embodiment of the invention. The record file 302 includes record file entry one 304A, record file entry two 304B through record file entry N 304N. The network includes source one 306A through source N 306N (collectively referred to as sources 306). Sources 306 send requests to the network element 308. Source one 306A sends request one 310A and request two 310B to network element 308. Source N 306N sends request N 310N to network element 308. Request one 310A through request N 310N are collectively referred to as requests 310.

The load generator server 312 includes a scheduler 314, which is within the load generation unit 316. The scheduler 314 is in communication with the record file 302 (e.g., in communication with a DB that stores the record file 302, is in communication with the network element 308 and can receive a record file 302 transmitted from the network element 308, or is in communication with a different network element used to generate the record file 302). Load generation unit 316 includes virtual client one 318A through virtual client N 318N (collectively, virtual clients 318), each of which is in communication with the scheduler 314. Virtual client one 318A transmits regenerated request one 320A and regenerated request two 320B. Virtual client N 318N transmits regenerated request N 320N.

Network element 308 is located in an operational network. Advantageously, when record file 302 is created (which is later used to create the regenerated requests for testing network elements), it is populated with data indicative of actual network traffic received by the network element 308. Generally, the network element 308 processes the requests 310 that it receives. In some embodiments, the network element 308 creates the record file 302 to describe requests 310 such that they can later be regenerated. For example, the network element 308 creates record file element one 304A, which includes data that describes request one 310A such that the load generator server 312 can regenerate request one 310A (e.g., regenerated request one 320A). This process is repeated for each request 310 that the network element receives. The network element 308 can create record file 302 based on responses (not shown) transmitted by network element 308 (e.g., responses to requests 310), or a combination of both requests 310 and the responses. Each source 306 is responsible for transmitting particular requests from the requests 310, and information indicative of the source is stored in the record file element 304 for the particular request.

In some embodiments, a different network element (a network element other than the network element being tested, such as an intermediate switch) that has access to the requests 310 and/or responses sent by network element 308 generates record file 302. For example, load generator server 312 generates the record file 302 based on responses that are retuned from network element 308 in response to requests 310A received by the network element 308 during normal operation. The load generator server 312 can also use the requests 310 to generate the record file 302, or a combination of both requests 310 and the responses. In another example, one or more of the sources 306 generate the record file 302 based on the requests 310 the sources 306 send and/or the responses the sources 306 receive from the network element 308.

Advantageously, the record file elements 304 reflect data saved by the network element 308 during its normal operation. Since the load generator server 312 generates the regenerated requests 320 based on the record file elements 304, each regenerated request 320 sent by the load generator server 312 mimics the requests 310A received by network element 308 (e.g., load levels and load types close to what network element 308 received during operation). Advantageously, the systems and methods described herein allow engineers to accurately determine the performance of a network element (e.g., by sending the regenerated requests 320 to network element 308 or a different network element) by transmitting (or replaying) past requests 310A as regenerated requests 320.

The record file 302 can be in the form of an event record, a request log, or any other form of record that describes the attributes of the received requests 310. As described above, the record file 302 can be formed from information in the requests 320 and/or the responses from the network element 308 to requests 320. In some embodiments, the record file 302 includes additional information that is not contained in the requests 320 or the responses (e.g., a unique reference number for each record file element 304 within the record file 302). For example, the network element 308 can be a softswitch deployed in an operational IMS network. In this example, each record file element 304 is a call detail record (CDR) generated by the network element 308. Each CDR is associated with a call. The data in each record file element can include, for example, data indicative of a calling number for a request associated with the record file element. For example, if the number (123)456-7890 initiated request one 310A, the network element 308 can store the number (123)456-7890 in the record file element one 304A (which network element 308 generates based on request one 310A). The data in each record file element can include data indicative of a receiving number for the request. For example, if request one 310A is sent for number (098)765-4321, the network element 308 can store the number (098)765-4321 in the record file element one 304A. The data in each record file element can include data indicative of a date of the request. For example, if request one 310A was sent on Feb. 2, 2010, the network element 308 can store this date in the record file element one 304A.

The data in each record file element 304 can include data indicative of a time of the request (e.g., if request one 310A was sent at 11:43 AM, the network element 308 can store this timestamp in the record file element one 304A). The data in each record file element can include data indicative of a duration of the request (e.g., if request one 310A is associated with a call duration of 2 minutes and 34 seconds, the network element 308 can store this timestamp in the record file element one 304A). The data in each record file element can include data indicative of a call type of the request (e.g., if request one 310A is associated with an AMA call type, a call type of O-Voice, A-SMS, etc., the network element 308 can store this call type in the record file element one 304A). The data in each record file element can include data indicative of a routing label for the request (e.g., the route by which the call associated with request one 310A entered the network, the route by which the call associated with request one 310A left the network). The data in each record file element can include data indicative of a Message Billing Indicator (MBI) for the request (e.g., an indicator for how the call will be billed). While various examples of data that the record file elements 304 can store have been described, any one or any combination of these can be used, in addition to other relevant information.

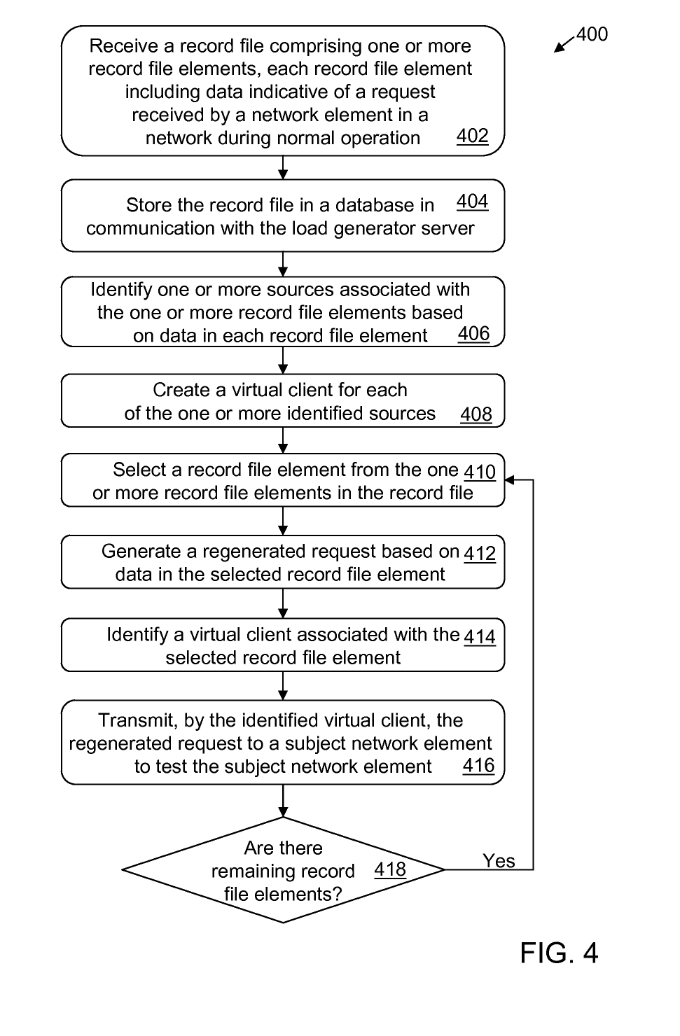

FIG. 4 is a schematic illustration of a computerized method 400 for testing network elements, according to an illustrative embodiment of the invention. Referring to FIG. 3, at step 402, the load generator server 312 receives the record file 302. The record file 302, the record file 302 including one or more record file elements 304. Each record file element 304 includes data indicative of a request received by a network element from a source in a network during normal operation (e.g., record file element one 304A includes data indicative of request one 310A, record file element two 304B includes data indicative of request two 310B, and so on). At step 404, the load generator server 312 stores the record file 302 in a database in communication with the load generator server 312 (e.g., DB 208 of FIG. 2). At step 406, the load generator server 312 identifies one or more sources (e.g., sources 306) associated with the one or more record file elements 304 based on data in each record file element 304. At step 408, the load generator server 312 creates a virtual client 318 for each of the one or more identified sources.

At step 410, the load generator server 312 selects a record file element (e.g., record file element one 304A) from the one or more record file elements 304 in the record file 302. At step 412 the load generator server 312 generates a regenerated request 320 based on data in the selected (e.g., corresponding) record file element from the one or more record file elements 304. At step 414, the load generator server 312 identifies a virtual client (e.g., virtual client one 310A) associated with the selected record file element 304. At step 416, the load generator server 312 transmits, by the selected virtual client, the regenerated request to a subject network element to test the subject network element (e.g., to network element 308 or a different network element). The one or more regenerated requests 320 simulate requests received by the network element 308 during normal operation. At step 418, the load generator server 312 determines whether there are any remaining record file elements 304 that have not yet been regenerated (e.g., using steps 410-416), and if there are, the method 400 continues at step 410 by selecting another record file element 304.

Method 400 will be explained using the example below. One skilled in the art will appreciate that the systems and methods disclosed herein can be applied to any network element that process requests and that can be used to generate some kind of log or record (e.g., a record file) that describes the received requests. In this example, the network element 308 is a softswitch. For example, the softswitch can be the PSX® Centralized Routing Server (PSX) from Sonus Networks, Inc. (a highly versatile call services, dial plan, digit manipulation and routing engine). The PSX can provide a number of services. For example, for call routing, the routing by the PSX depends on a variety of factors such as the calling number, the ingress Trunk Group (TG, which can be, for example, an IP TG or a PSTN TG), the carrier code, the called number, the calling local access and transport area (LATA), and other related factors. Further, digit manipulation can be applied at various points in the PSX call processing and services flow. The PSX also allows also calls to dip external databases for further call treatment. As a result of all of this versatility of the PSX, accurately benchmarking the performance footprint and capacity of the softswitch by traditional methods is close to impossible.

Additionally, in this example, the sources 306 are media gateways. The media gateways can be, for example, a GSX® Open Service Switch (GSX) available from Sonus Networks, Inc. Advantageously, the systems and methods disclosed herein allow engineers to accurately determine the performance of the PSX by replaying past calls (e.g., regenerating past calls and replaying them such that the regenerated calls are identical to the original calls) through the PSX (e.g., using the Diameter+protocol provided by Sonus Networks, Inc.). Other network elements can be emulated to test the PSX. For example, a feature server can be emulated that delivers IP-based VoIP call features over various access technologies (e.g., voice-over-DSL, voice-over-WiFi and WiMax, voice-over-cable and Ethernet). The feature server can be, for example, an ASX® Feature Server available from Sonus Networks, Inc. Another exemplary network element is an IP-to-IP interconnect switch, such as, for example, the Sonus Network Border Switch (NBS) available from Sonus Networks, Inc.

The load generator server 106 generates workload to the PSX, and also collects and analyzes related performance metrics (e.g., via the load generation unit 210 of FIG. 2). Referring to step 402, the GSX produces the record file 302, which is a list of CDRs that account for all the requests sent to the PSX. In some embodiments, the GSX creates multiple requests 310 related to the same call (or CDR). For example, if a call route (e.g., the route in the routing label sent by the PSX in response to a request from the GSX) is congested or broken, the GSX can dip (or send an additional request) to the PSX to get a different route, if available. The structure of a request 310 can be flexible and extendible. For example, each request 310 can include different fields, wherein different combinations of such fields cause the PSX to process the request differently, and consequently to transmit a different response to the GSX.

The record file 302 includes, for example, CDRs for all the requests sent to the PSX while deployed in an operational network. The CDRs can include CDRs that indicate the start (e.g., the start time) of a request (start CDRs). Start CDRs can be generated when a call is successfully completed (e.g., a connect is received by the source 306 and the call is cut-through (the telephone number of the destination party is dialed)). The CDRs can also include CDRs that indicate the end of a request (stop CDRs, which can include, for example, data for the stop time of a request and the call holding time of the request). Stop CDRs can be generated when a call that was successfully completed is terminated. The CDRs can also include CDRs that indicate attempted requests (attempt CDRs). Attempt CDRs can be generated on termination of a call that was not completed. The CDRs can also include CDRs that indicate intermediate requests (intermediate CDRs, which are generated, for example, at periodic intervals while the call is established). There are various other types of CDRs, some of which may not be useful for regenerating requests sent to the network element 308. For example, some CDRs may indicate the state of the source 306 (e.g., a GSX can send a message indicative of a reboot when the GSX reboots, the GSX can send a message indicative of a software change upon successful completion of the software upgrade, etc.). In some embodiments, the preferred CDRs to use to generate the regenerated requests 320 are start CDRs, stop CDRs, attempt CDRs, and/or intermediate CDRs.

The load generator server 106 uses the CDRs to generate policy requests to send to the PSX. The load generator server 106, using the load generation unit 104, reads the CDR records, filters the records, and generates the load on the PSX using the CDRs. The load generator server 106 can preprocess the record file 302 to remove any unnecessary CDRs from the record file 302. For example, the load generator server 106 can parse the CDRs in the record file 302 to filter out CDRs other than stop CDRs and attempt CDRs. Advantageously, all requests sent to the PSX, including both successful and failed requests, can be regenerated based on the preprocessed record file 302.

Referring to steps 406 and 408, the scheduler 314 uses the appropriate virtual client from the virtual clients 318 to send the regenerated requests 320. By creating virtual clients 318 for each of the original sources 306 of the requests 310, the same transmission setup is created when testing a network element. For example, if there are three sources 306 of the requests 310 used to generate the record file 302, and each source 306 sends an associated group of requests 310, then the load generation unit 316 creates three virtual clients 318 and transmits the associated group of requests for each source 306 through the virtual client that emulates the source. Referring to the example, the load generator server 106 identifies one or more source GSXs that sent requests to the PSX by iterating through each CDR to generate a list of GSXs. For example, if there are five CDRs, two that include data for requests sent from a first GSX and three that include data for requests that were sent from a second GSX, then the list of GSXs includes the first and second GSX. The load generator server 106 creates a virtual first GSX and a virtual second GSX (i.e., a virtual GSX (e.g., virtual client 318) for each of the identified source GSXs). As will be explained below with reference to FIG. 7, the virtual GSXs are used to emulate the real GSXs that sent the requests used to generate the record file 302.

Referring to steps 410-412, the load generator server 106 generates regenerated requests for each CDR in the record file 302. For example, the load generation unit 316 iterates to the next CDR in the record file 302, which is a stop CDR. As described above, the stop CDR includes, among other fields, the creation time of the stop CDR (e.g., the time when the stop request was sent to the PSX) and the call holding time of the request associated with the stop CDR (e.g., the duration of the call that was stopped). The load generation unit 316 determines the call start time of the call associated with the stop CDR by subtracting the call duration time from the creation time of the stop CDR. For example, if the creation time of the stop CDR is 11:43:06 AM and the call holding time is 27 seconds, the start time of the call (e.g., the time the CDR that created the call was sent) is 11:42:39 AM. Similarly, for example, the load generation unit 316 can use the creation time of an attempt CDR to determine when a failed request was transmitted to the PSX.

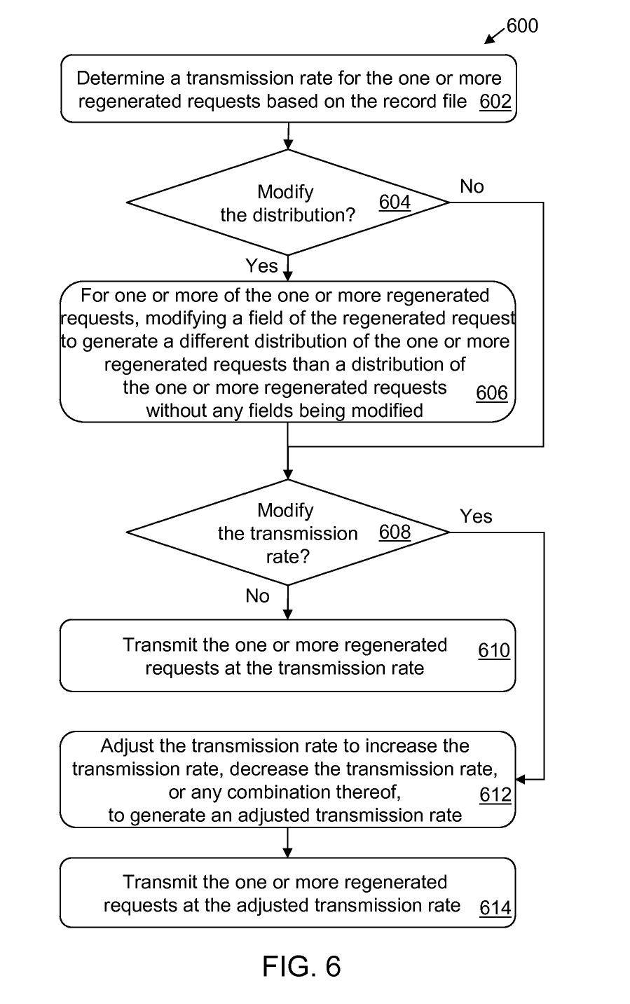

Referring to steps 414-416, the load generator server 106 identifies which virtual GSX to use to transmit each regenerated request to the PSX. Because the load generator server 106 sends the regenerated requests to the PSX through the virtual GSXs, advantageously the requests transmitted to the PSX appear as if they came from multiple GSXs. The requests simulate actual request patterns that occurred during normal operation. The load generator server 106 uses, for example, the PSX Diameter+API to create and send the policy requests to the PSX. As is described below with reference to FIG. 6, the load generator server 106 transmits the regenerated requests according to a configurable schedule. The scheduler 314 can alter the schedule to, for example, adjust the transmission rate of the requests, perform load balancing, and to make other configurable changes to tailor the testing.

Referring to step 416, in some examples, the load generation unit 316 can transmit the regenerated requests 320 to the same network element (e.g., network element 308) whose requests and/or responses were used to generate the record file 302. In some examples, the load generation unit 316 can transmit the regenerated requests 320 to a different network element than the network element used to generate the record file 302. Using either method, the network element tested is advantageously tested using real-world data that accurately mimics that which the network element will be (or is) subject to in an active network. Referring to the example, the PSX used to generate the record file 302 does not need to be the PSX being tested. For example, a first PSX that is deployed in an operational network can be used to generate the record file 302, and the load generator server 106 can use record file 302 to test a second PSX (e.g., a PSX that needs to be tested before deployment in an active network). Similarly, the PSX used to generate the record file 302 can also be the PSX the load generator server 106 tests (e.g., a PSX that is deployed in an active network, so the load generator server 106 uses the record file 302 to periodically test the deployed PSX to ensure it is properly performing).

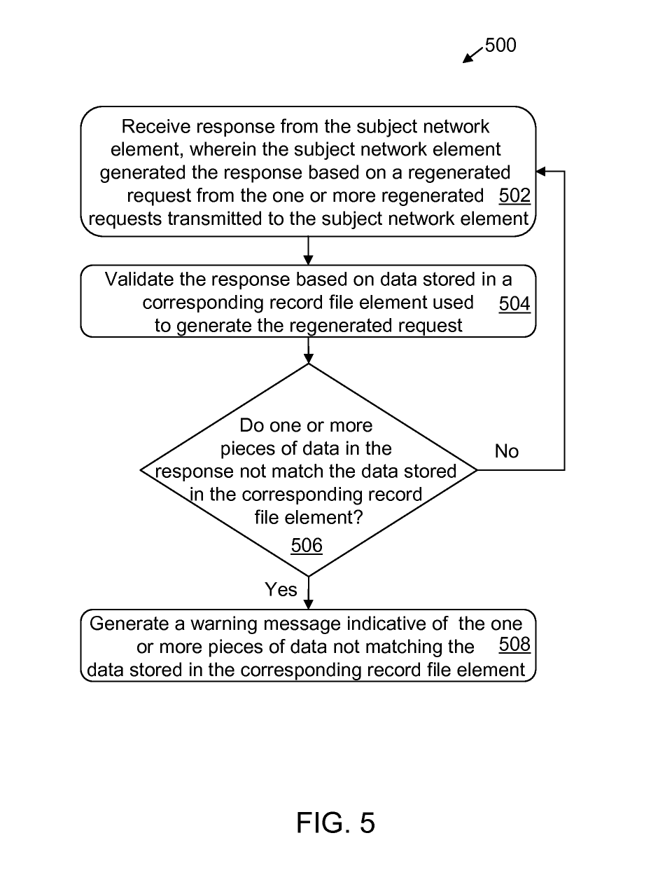

The load generator server (e.g., load generator server 312) can use information in the responses from the network element being tested to verify the performance of the network element. FIG. 5 is a schematic illustration of a method 500 for validating responses received from the network element under test, according to an illustrative embodiment of the invention. Referring to FIGS. 2 and 3, at step 502 the load generator server 204/312 receives responses from the subject network element being tested (e.g., the network element 202), wherein the subject network element generated each response based on a regenerated request from the one or more regenerated requests (e.g., regenerated requests 320) transmitted to the subject network element. At steps 504, the test results analysis unit 206 validates the response based on data stored in a corresponding record file element used to generate the regenerated request. At step 506, the test results analysis unit 206 determines whether one or more pieces of data in the response do not match the data stored in the corresponding record file element. If the data does not match, the method 500 proceeds to step 508, where the test results analysis unit 206 generates a warning message indicative of the one or more pieces of data not matching the data stored in the corresponding record file element. If the data does match, the method 500 proceeds back to step 502.

Referring to step 502 and FIGS. 2 and 3, the responses are transmitted by the network element 202 (e.g., the network element being tested) in response to the regenerated requests 320. The responses can include data that is also stored in the record file elements 304. For example, the responses can include a call type, a routing label, an MBI, and other fields described with reference to the record file element 304 of FIG. 3.

Referring to steps 504 and 506, the test results analysis unit 206 validates the response data based on the data stored in the record file element 304 that was used to generate the regenerated request 320 (which is the same regenerated request 320 the network element 202 sent the response in reply to). Continuing the GSX/PSX example described with reference to FIG. 4, the test results analysis unit 206 parses the received policy responses transmitted by the PSX in response to the regenerated requests 320, and matches the fields received from the PSX against the ones reported in the corresponding CDR. For example, the test results analysis unit 206 can verify the call type, the routing label, the MBI, and/or other information contained in the response.

Referring to step 508, if one or more of the data fields do not match, the test results analysis unit 206 generates a warning message. For example, a warning message can be printed to a log file. For each field the test results analysis unit 206 verifies, the warning message can include the value retuned in the policy response, the value in the associated CDR, and a pointer to the CDR in the record file 302. Advantageously, the test results analysis unit 206 can verify the performance of the network element 202. For example, in response to a service request from a GSX, the PSX returns a routing label for the GSX (e.g., a routing string that describes routing information the GSX is to use for the particular service request). In response to a regenerated request 320 transmitted by the load generator server 312, the PSX under test may return either the same routing label or a different routing label. For example, if the PSX software is upgraded, if there is a mistake with the upgrade the PSX may return a different routing label than that which it would have returned to the same request using the old software. The test results analysis unit 206 can verify this and other fields in the response transmitted by the PSX to validate the integrity of the PSX after changes to the PSX and/or the network that could impact the performance of the PSX.

Referring to steps 504-508, the test results analysis unit 206 can monitor the performance of the network element under test. For example, the test results analysis unit 206 can record the CPU state of the network element, the response time of the network element, and other performance metrics of the hardware and/or software of the network element. The test results analysis unit 206 can evaluate these recorded performance metrics. For example, the test results analysis unit 206 can correlate these performance metrics with the requests (e.g., requests 310 and/or regenerated requests 320) by correlating the performance metrics to the transmission rate of the requests, the type of requests (e.g., internal requests that do not require any external queries, or external requests that require external queries).

The load generator server can send the regenerated requests just as they were originally sent to the network element used to create the record file, or the load generator server can manipulate the regenerated requests before transmitting them to the network element(s) under test. FIG. 6 is a schematic illustration of a method 600 for adjusting the transmission of regenerated requests, according to an illustrative embodiment of the invention. Referring to FIG. 3, at step 602 the scheduler 314 determines a transmission rate for the one or more regenerated requests 320 based on the record file 302. At step 604, the scheduler 314 determines whether to modify the distribution of the regenerated requests 320. If the scheduler 314 is to modify the distribution, the method 600 proceeds to step 606. At step 606, for one or more of the one or more regenerated requests, the scheduler 314 modifies the one or more fields of the regenerated request to generate a different distribution of the one or more regenerated requests than a distribution of the one or more regenerated requests without any fields being modified. If the scheduler 314 is not to modify the distribution, the method 600 proceeds to step 608.

At step 608, the scheduler 314 determines whether to modify the transmission rate of the regenerated requests 320. If the scheduler 314 does not modify the transmission rate of the regenerated requests 320, the method 600 proceeds to step 610, and the scheduler 314 transmits the one or more regenerated requests at the unmodified transmission rate. If the scheduler 314 is to modify the transmission rate, the method proceeds to step 612, and the scheduler 314 adjusts the transmission rate to increase the transmission rate, decrease the transmission rate, or any combination thereof, to generate an adjusted transmission rate. At step 614, the scheduler transmits the one or more regenerated requests 320 at the adjusted transmission rate.

Referring to step 602, the initial transmission rate is the transmission rate that is implicitly recorded in the record file 302. This initial transmission rate can be determined based on the record file elements in the record file 302. For example, the initial transmission rate is determined based on the transmission times of the requests associated with each record file element 304 (e.g., either as stored in the record file elements 304, or if not actually stored in the record file elements 304, as calculated by the load generator server 312 based on the record file elements 304). For example, the initial transmission rate is the rate the requests 310 were transmitted to the network element 308 during normal operation of the network element 308.

Referring to steps 604-606, the load generator server 312 can modify the distribution of the regenerated requests 320 to emulate scenarios of interest (e.g., rather than directly generating the regenerated requests 320 from the record file 302). For example, the distribution can be modified to test “what-if” scenarios (e.g., what if the distribution of high priority to low priority requests is increased and/or decreased, and other request scenarios that the network element may be subjected to), or to determine how the network element (e.g., network element 202) responds to a new service before activating the new service in the network. For example, if there are different types of requests 310, where each type of request has a different priority or different processing requirements, the load generator server 312 can manipulate the original record file 302 to generate different distributions of the requests. For example, a test can be configured to transmit 80% of the regenerated requests 320 as high priority requests and 20% of the regenerated requests 320 as low priority requests. Various tests can be run with different ratios to evaluate how well the network element responds to the increased or decreased distribution of regenerated requests 320.

The load generator server 312 can be configured to test multiple network elements. For example, the load generator server 312 can test a primary network element as well as one or more standby network elements, such that the load generator server 312 can start sending the regenerated requests 320 to the primary network element and if the primary network element does not respond, then to send the regenerated requests 320 to the secondary network element. Referring to FIG. 1, for example, the load generator server 312 can be configured to test the plurality of network elements 102 (e.g., a plurality of PSXs). Various distribution schemes can be used to transmit the request amongst the plurality of network elements 102. In some embodiments, the load generator server 312 can transmit the one or more regenerated requests 320 to a first subject network element, network element one 102A. The one or more regenerated requests 320 comprise data indicative of instructions for the first subject network element one 102A to forward the one or more regenerated requests to a second subject network element, network element two 102B, and so forth until the request is transmitted to all of the network elements 102. The first subject network element one 102A can be configured to forward each regenerated request 320 before transmitting a response to the load generator server 312.

In some embodiments, the load generator server 312 load balances the one or more regenerated requests between the multiple network elements (e.g., between the first subject network element one 102A and the second subject network element two 102B). The load generator server 312 can perform the load balancing based on information collected by the operational network elements (e.g., network element 308), or can be independently configured on the load generator server 312. In some examples, the load generator server 312 sends each regenerated request 320 to each of the plurality of network elements 102. In some examples, it may be desirable to distribute the load of the regenerated requests 320 (e.g., the number of regenerated requests 320 that are transmitted to network element one 102A, the number of regenerated requests 320 that are transmitted to network element two 102B, and so forth). For example, the load of the regenerated requests 320 can be distributed based on the overload state of the subject network elements 102. The load generator server 312 can adjust the load of regenerated requests 320 (e.g., the number of regenerated requests 320 sent to a network element 102 per period of time) sent to each network element 102 based on an overload state of the network element 102 (e.g., the network element is at 20% of capacity, 40% of capacity, etc.). For example, given a particular set of network elements 102, each network element will most likely have a unique overload level, such that network element one 102A comprises a first overload state, network element two 102B comprises a second overload state, and so forth. In some embodiments, the load of regenerated requests 320 sent by the load generator server 312 can be configured inversely proportional to the overload state of the network element. For example, if the load generator server 106 is testing just the network element one 102A with an overload state of 40% and the second network element two 102B with an overload state of 60%, the load generator server 106 can send 60% of the regenerated requests 320 to the network element one 102A and 40% of the regenerated requests 320 to the network element two 102B.

Referring to steps 608-614, the load generator server 312 can provide different modes for replaying the original requests. The scheduler 314 sends the regenerated requests 320 to the network element according to a configured schedule. The scheduler 314 can support various types of scheduling, such as fixed rate scheduling, Poisson distribution-based scheduling, scheduling based on the timestamps of the record file elements 304, and other scheduling methodologies. For example, the scheduler 314 can transmit the one or more generated requests 320 at the initial transmission rate (e.g., at the same pace the sources 306 transmitted the original requests 310 to the network element 308), the scheduler 314 can modify the initial transmission rate to increase or decrease the transmission rate of the generated requests 320, and/or the scheduler 314 can transmit the one or more generated requests 320 at a given fixed rate or a given rate distribution. In some embodiments, the load generator server 312 performs multiple tests of a network element 308, the first test transmitting the generated requests 320 at the initial transmission rate to determine a baseline of the network element 308, and then the transmission rate can be adjusted to perform subsequent tests against the network element 308. The rate adjustments can be based on feedback from the network element under test (e.g., based on the overload state of the network element).

The scheduler 314 can also automatically adjust the transmission rate based on network settings or settings associated with the network element under test. In some embodiments, the scheduler 314 throttles the regenerated requests 320 based on the call gapping settings returned in the policy responses transmitted from the network element under test when overload control is enabled on the network element. Referring to FIG. 3, the load generator server 312 receives the responses from the network element under test, wherein the responses include one or more load control messages (e.g., call gapping settings, such as to send the network element under test one out of every four requests) from the subject network element indicative of data for load control. The load generator server 312 (e.g., via the scheduler 314) adjusts the transmission of the one or more regenerated requests 320 to adjust a transmission rate of the transmission (e.g., as explained with reference to steps 608-614), a distribution of the transmission (e.g., as explained with reference to steps 604-606), or any combination thereof, based on the load control messages.

FIG. 7 is a schematic illustration of a method 700 for emulating request sources (e.g., virtual clients 318 of FIG. 3), according to an illustrative embodiment of the invention. At step 702, the load generator server 312 determines, for each of the regenerated requests 320, whether the subject network element (e.g., network element 202 of FIG. 2) failed to respond to a regenerated request (e.g., within a predetermined time-out period). If the load generator server 312 did not receive a request for a particular regenerated request 320, the load generator server 312 retransmits the regenerated request. If the load generator server 312 received a response for each of the regenerated requests 320, then the method 700 proceeds to step 706. At step 706, the load generator server 312 determines whether it (e.g., via the virtual clients 318) is currently transmitting regenerated requests to the subject network element. If the load generator server 312 is transmitting regenerated requests, the method 700 proceeds back to step 702. If the load generator server 312 is not transmitting regenerated requests to the subject network element, the load generator server 312 transmits one or more maintenance messages to the subject network element to verify a connection between the subject network element and the load generator server.

Referring to step 702, the load generator server 312 (e.g., via the load generation unit 316) keeps track of measured metrics for the regenerated requests 320. For example, the load generator server 312 can be configured to track the pending regenerated requests 320, correlate the received policy responses with the appropriate regenerated request from the regenerated requests 320, measure different metrics for the regenerated requests 320 (e.g., the request-response delay between the time the regenerated request was sent and the associated response was received, the number of timed-out requests, etc.), and to perform other related actions. The measured metrics can be stored for later use (e.g., the measured metrics can be stored in a comma-separated values (csv) file every N regenerated requests, where N is a configurable parameter).

Referring to step 704, the load generator server 312 can be configured to emulate the retransmission of regenerated requests 320 (e.g., policy requests). Advantageously, the virtual clients 318 can mimic the reaction to lost and/or timed-out requests through retransmission. The settings for the retransmission behavior can be either retrieved from the record file 302 and/or can be configured on the load generator server 312. Various configuration parameters can be used (e.g., by the scheduler 314) to control the re-transmission behavior of timed-out regenerated requests. For example, the scheduler 314 can control the retransmission based on the allowed number of retransmissions (e.g., which can be configurable through the load generator server 312), the initial value of the predetermined time-out interval, and/or the subsequent value of the predetermined time-out interval after the first retransmission (e.g., the load generator server 312 can be configured to adjust the predetermined time-out interval for one or more regenerated requests 320 based on the number of times the regenerated requests 320 timed out).

Referring to step 708, the load generator server 312 can emulate control messages that are transmitted in addition to the regenerated requests 320. For example, keepalives may be sent by the sources 306 to the network element 308 to verify the network element 308 is currently operational (e.g., the GSX sends keepalives to check if the PSX is still alive). The control messages (e.g., keepalives) may include fields to correlate a regenerated request with the associated response (e.g., using sequence numbers), information about the state of the source 306 (e.g., the current load level of the source 306), and any other information that is useful for the network element 308.

In some examples, each of the sources 306 send keepalives independent from the others (i.e., there is no shared knowledge between the sources 306). Advantageously, the scheduler 314 can transmit control messages independently using each of the virtual clients 318. Referring to step 706, in some examples the control messages are only sent from a source 306 when the source 306 is not sending requests to the network (e.g., the requests acts as implicit keepalives because if the network element responds to a request the source 306 knows the network element is operational). The scheduler 314 can be configured to emulate this behavior by sending control messages if the load generator server 312 is not sending any regenerated requests 320 (e.g., not sending any regenerated requests 320 within a predetermined time period).

In some examples, the control messages include a message to register each the virtual client (e.g., virtual clients 318) with the subject network element before transmitting any of the one or more regenerated requests 320 from the virtual clients 318 to the subject network element. For example, the load generation unit 316 can be configured such that creating the virtual client includes transmitting a registration message from the virtual client to the subject network element.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized method for testing network elements in a communication network, the method comprising:
receiving, by a load generator server, a record file comprising one or more record file elements, each record file element including data indicative of a request received by a network element in a network during normal operation;
storing, by the load generator server, the record file in a database in communication with the load generator server;
identifying, by the load generator server, one or more sources associated with the one or more record file elements based on data in each record file element;
creating, by the load generator server, a virtual client for each of the one or more identified sources;
for each of the one or more record file elements in the record file, generating, by the load generator server, one or more regenerated requests, each of the one or more regenerated requests being generated based on data in a corresponding record file element from the one or more record file elements; and
for each of the one or more regenerated requests, transmitting, by the virtual client associated with the regenerated request, the regenerated request to a subject network element to test the subject network element, wherein the one or more regenerated requests simulate requests received by the network element during normal operation.

2. The method of claim 1, wherein the record file is generated by the network element based on one or more requests received by the network element and one or more responses transmitted by the network element, during normal operation, the record file is generated by a second network element based on the one or more requests and the one or more responses, or any combination thereof.

3. The method of claim 1, wherein the network element is a softswitch, the communications network is a telecommunications network, and each record file element is a call detail record (CDR).

4. The method of claim 3, wherein the one or more record file elements comprise a stop CDR, the method further comprising, for each of the one or more regenerated requests, determining a call start time for the regenerated request based on a creation time of an associated stop CDR and a call holding time of the associated stop CDR.

5. The method of claim 1, wherein the data in each record file element comprises data indicative of a calling number for a request associated with the record file element, data indicative of a receiving number for the request, data indicative of a date of the request, data indicative of a time of the request, data indicative of a duration of the request, data indicative of a call type of the request, data indicative of a routing label for the request, data indicative of a message bill indicator for the request, or any combination thereof.

6. The method of claim 5, further comprising:
receiving a response from the subject network element, wherein the subject network element generated the response based on a regenerated request from the one or more regenerated requests transmitted to the subject network element; and
validating the response based on data stored in a corresponding record file element used to generate the regenerated request.

7. The method of claim 6, wherein validating comprises:
determining one or more pieces of data in the response do not match the data stored in the corresponding record file element; and
generating a warning message indicative of the one or more pieces of data not matching the data stored in the corresponding record file element.

8. The method of claim 1, further comprising determining a transmission rate for the one or more regenerated requests based on the record file.

9. The method of claim 8, wherein transmitting comprises:
transmitting the one or more regenerated requests at the transmission rate; or
adjusting the transmission rate to increase the transmission rate, decrease the transmission rate, or any combination thereof, to generate an adjusted transmission rate; and
transmitting the one or more regenerated requests at the adjusted transmission rate.

10. The method of claim 1, wherein generating comprises, for one or more of the one or more regenerated requests, modifying one or more fields of the regenerated request to generate a different distribution of the one or more regenerated requests than a distribution of the one or more regenerated requests without any fields being modified.

11. The method of claim 1, wherein creating the virtual client for each of the one or more identified sources comprises registering the virtual client with the subject network element before transmitting any of the one or more regenerated requests from the virtual client to the subject network element.

12. The method of claim 1, further comprising transmitting one or more maintenance messages to the subject network element to verify a connection between the subject network element and the load generator server.

13. The method of claim 1, further comprising:
determining the subject network element failed to respond to a regenerated request from the one or more regenerated requests within a predetermined time period; and
retransmitting the regenerated request to the subject network element.

14. The method of claim 1, wherein the subject network element comprises load control, the method further comprising:
receiving one or more load control messages from the subject network element indicative of data for load control; and
adjusting the transmission of the one or more regenerated requests to adjust a transmission rate of the transmission, a distribution of the transmission, or any combination thereof, based on the load control messages.

15. The method of claim 1, wherein the subject network element and the load generation server are deployed in a testing network, deployed in an operational network, or any combination thereof.

16. The method of claim 1, further comprising transmitting the one or more regenerated requests to a plurality of subject network elements, comprising:
transmitting the one or more regenerated requests to a first subject network element, wherein the one or more regenerated requests comprise data indicative of instructions for the first subject network element to forward the one or more regenerated requests to a second subject network element; or
load balancing the one or more regenerated requests between the first subject network element and the second subject network element; or any combination thereof.

17. The method of claim 16, wherein load balancing comprises transmitting the one or more regenerated requests based on a first overload state of the first subject network element and a second overload state of the second subject network element.

18. A computer program product, tangibly embodied in a computer readable storage medium, the computer program product including instructions being operable to cause a data processing apparatus to:
receive a record file comprising one or more record file elements, each record file element including data indicative of a request received by a network element in a network during normal operation;
store the record file in a database in communication with the load generator server;
identify one or more sources associated with the one or more record file elements based on data in each record file element;
create a virtual client for each of the one or more identified sources;
for each of the one or more record file elements in the record file, generate one or more regenerated requests, each of the one or more regenerated requests being generated based on data in a corresponding record file element from the one or more record file elements; and
for each of the one or more regenerated requests, transmit the regenerated request to a subject network element to test the subject network element, wherein the one or more regenerated requests simulate requests received by the network element during normal operation.

19. An apparatus for testing network elements in a communication network, the apparatus comprising:
a database configured to store record files; and
a load generator server in communication with the database, the load generator server being configured to:
receive a record file comprising one or more record file elements, each record file element including data indicative of a request received by a network element in a network during normal operation;
store the record file in the database;
identify one or more sources associated with the one or more record file elements based on data in each record file element;
create a virtual client for each of the one or more identified sources;
for each of the one or more record file elements in the record file, generate one or more regenerated requests, each of the one or more regenerated requests being generated based on data in a corresponding record file element from the one or more record file elements; and
for each of the one or more regenerated requests, transmit the regenerated request to a subject network element to test the subject network element, wherein the one or more regenerated requests simulate requests received by the network element during normal operation.
